(19) United States
(12) Patent Application Publication
(10) Pub. No.: US 2025/0135432 A1
(43) Pub. Date: May 1, 2025

(54) Synthesis and application of citric acid based MOFs

(71) Applicant: Decarbontek LLC, Woburn, MA (US)

(72) Inventor: Yong Ding, Waban, MA (US)

(21) Appl. No.: 18/919,753

(22) Filed: Oct. 18, 2024

Related U.S. Application Data
(60) Provisional application No. 63/593,627, filed on Oct. 27, 2023.

(51) Int. Cl. B01J 20/22; B01D 53/02; B01J 20/30; C07F 19/00

(52) U.S. Cl. CPC B01J 20/226; B01D 53/02; B01J 20/3085; C07F 19/005; B01D 2253/204; B01D 2257/302; B01D 2257/304; B01D 2257/504; B01D 2258/0283; B01D 2258/06

(57) ABSTRACT

A method for preparing a MOF of formula K₂(M1ₓM2₁₋ₓ)₃(Cit)₂, where Cit is fully dehydrogenated citrate anion, M1 and M2 are metal cations of Zn, Co, Cu, Mg, Ni, Ca, Mn, Cr, Zr, and Fe, includes reacting 1 molar equivalent of citric acid with 0 to 1.0 molar equivalent of metal carbonate and/or metal oxide and 1.5 to 0.5 molar equivalent of a basic potassium compound (e.g., potassium carbonate, potassium bicarbonate and/or potassium hydroxide), where a total molar equivalent of the metal carbonate and potassium carbonate is 1.5. This step is followed by reacting with a metal salt aqueous solution. The total molar equivalent of the metal carbonate and/or metal oxide and metal acetate is 1 to 1.5. The reaction steps are conducted in DI water at a temperature below 100° C. and at ambient pressure. The MOF can be used to adsorb an acid gas from a fluid stream.

### RELATED APPLICATIONS

This application claims the benefit under 35 USC 119(e) of U.S. Provisional Application No. 63/593,627, filed on Oct. 27, 2023, which is incorporated herein by this reference in its entirety.

### BACKGROUND OF THE INVENTION

Carbon capture, utilization and storage (CCUS) generally refers to various technologies believed to play an important role in meeting global energy and climate goals. For instance, these technologies are considered by many as essential in keeping global temperature increases below 1.5 degrees centigrade (° C.).

CCUS involves capturing CO₂ from diluted gas streams, such as flue gas, air, etc. In the case of flue gas, the CO₂ concentration is in the range of 4 to 14 volume %; in the case of ambient atmospheric air, the CO₂ concentration is about 450 ppm. Currently, the upfront cost for CO₂ capture from a variety of streams is more than 80% of the total CCUS costs. In the case of direct air capture, the upfront cost for CO₂ capture is almost 99% of the total CCUS cost.

The primary method for CO₂ capture involves aqueous amine based solvent systems, such as Econamine FG+, KS-1, Oase Blue, and Cansolv. However, these amine-based systems suffer from high energy loss from regenerating the solvent (due to boiling and condensing 70% of water). Another significant energy penalty is the energy consumed for pumping a large amount of viscous solvents during solvent circulation. Furthermore, solvent based systems suffer from water loss and solvent loss, resulting in large amounts of water and solvent needing to be replenished. Also, the solvent loss itself contributes to global emissions and is a potential health hazard.

Solid adsorbents, such as metal organic frameworks (MOFs), diamine-appended MOFs, covalent organic frameworks (COFs), zeolites, porous silicas, porous polymeric powders, etc. have attracted significant attention, as they can potentially achieve a high adsorption efficiency with much less energy consumption. UTSA-16, a MOF material derived from citric acid, is a highly promising material for CO₂ capture owning to its isotherm features, mechanism of adsorption, and stability. An illustrative UTSA-16 type MOF is composed of Co (II) ion nodes and cobalt citrate clusters in an octahedral geometry surrounded by four K⁺ ions. Features considered important for its CO₂ capture attributes include three-dimensional M-O-M connections, K-polyhedral linkers, and coordinated terminal water molecules. See, e.g., Microporous metal-organic framework with potential for carbon dioxide capture at ambient conditions, by S. Xiang et al., Nature Comm., 2012, 3, page 954; CO2 Adsorption Sites in UTSA-16: Multitechnique Approach, by A. Masala, et al., J. Chem. Phy. C, 2016, 120, page 12068; New insights into UTSA-16, by A. Masala, et al., Phys. Chem. Chem. Phys., 2016, 18, page 220; CO2 capture in dry and wet conditions in UTSA-16 metal organic framework, by A. Masala, et al., ACS Appl. Mater. Interfaces 2017, 9, page 455.

However, until now, all reported syntheses for this material are based on the procedure reported in A 3D Canted Antiferromagnetic Porous Metal-Organic Framework with Anatase Topology through Assembly of an Analogue of Polyoxometalate, by S. Xiang et al., J. Am. Chem. Soc., 2005, 127, page 16352. The S. Xiang et al. synthesis protocol utilizes large amounts of an ethanol-water solvent mixture (in a 50%/50% ratio) to mix the precursors (solvent volume to citric acid weight ratio is about 30 L/kg), followed by isothermal heating for 48 hours at 120° C., corresponding to autogenous pressures of 4 to 6 bar. Such solvothermal synthetic approach requires specialized reactors and involves large amounts of organic solvents. Ongoing attempts to scale up the product are hindered by the inability to reduce the synthesis temperature below the boiling point of the solvent.

U.S. Pat. No. 11,896,951 (Zhao et al.), granted on Feb. 13, 2024, disclosed MOFs derived from citric acid containing bimetallics (Co and Zn) that can be synthesized at relatively low temperature (such as 60° C., for example). However, the method disclosed still requires a large amount of organic solvent (a solvent volume to citric acid weight ratio of over 13 L/kg).

The research paper A microwave method for the rapid crystallization of UTSA-16 with improved performancefor CO2 capture by Sanjit Gaikwad, and Sangil Han, in Chem. Eng. J., 2019, 371, page 813, reported the synthesis of UTSA-16(Co) utilizing microwave at 90° C. which significantly reduced the reaction temperature and time. This synthetic approach, however, requires not only special equipment, but also a large amount of organic solvent. The solvent volume to citric acid weight ratio is about 30 L/kg. The same microwave synthetic protocol has been extended to synthesize the MOFs UTSA-16(Zn) (see Novel metal-organic framework of UTSA-16 (Zn) synthesized by a microwave method: Outstanding performance for CO₂ capture with improved stability to acid gases, by Sanjit Gaikwad et al., J. Ind. Eng. Chem., 2020, 87, page 250). The article Green and facile production of UTSA-16 (Zn) in aqueous media with improved CO2 adsorption performance by Sanjit Gaikwad et al., J. Ind. Eng. Chem., 2023, 126, page 444, reported the synthesis of UTSA-16(Zn) utilizing only water as the solvent. However, the approach still requires microwave energy and the solvent volume to citric acid weight ratio is in excess of 22 L/kg.

The article Bimetallic Ni-Co-based metal-organic framework: An open metal site adsorbent for enhancing CO2 capture by Yekta Abdoli et al., Appl. Organometal Chem. 2019; e5004 reported the synthesis of bimetallic (Ni and Co) UTSA-16 MOFs and their CO₂ adsorption capacities. These MOFs were synthesized using the standard solvothermal process utilizing 50%/50% ethanol/water mixture as the solvent. The article Bimetallic UTSA-16 (Zn, X; X=Mg, Mn, Cu) metal organic framework developed by a microwave method with improved C02 capture performances by Ranjit Gaikwad et al., J. Ind. Eng. Chem., 2022, 111, page 346, reported the synthesis of bimetallic UTSA-16 based MOFs. These MOFs were synthesized utilizing 50%/50% ethanol/water mixture as the solvent and a microwave reactor. The solvent volume to citric acid weight ratio was 23.8 L/kg.

### SUMMARY OF THE INVENTION

A need continues to exist for synthetic methods that can be employed to prepare UTSA-16 type adsorbents. Particularly desired are procedures that can be conducted in water, at ambient pressure and at temperatures that do not exceed and typically are lower than the boiling point of the solvent, e.g., 100 degrees centigrade (° C.) in the case of water. Approaches that do not entail complex reactors and/or microwave energy remain of interest.

In some of its aspects, the invention relates to the synthesis of a MOF having the general formula of K₂(M1ₓM2₁₋ₓ)₃(Cit)₂, where Cit is fully dehydrogenated citrate anion, M1 and M2 are independently selected metal cations of Zn, Co, Cu, Mg, Ni, Ca, Mn, Cr, Zr, or Fe, and x is in the range from 0 to 1. In specific embodiments, the MOF has the UTSA-16 structure.

It was discovered, surprisingly and unexpectedly, that such a MOF, also referred to herein as a “citrate MOF”, can be manufactured without using any organic solvent, at a temperature no greater than and typically below about 100° C., and at ambient pressure, also referred to herein as “atmospheric pressure”, with the understanding that it is the atmospheric pressure at the location where the synthesis is carried out. The MOF could be formed by reacting potassium citrate with a metal salt component (a single metal (e.g., M1 or M2) salt or a mixture of metal (e.g., M1+M2) salts), in a solvent consisting of water, typically deionized (DI) water. Reaction times ranged from 2 hours (h) to 48 h, e.g., from 4 h to 24 h.

In many implementations, the molar ratio of potassium citrate to the metal salt component is 1:1. Surprisingly and unexpectedly, it was also discovered that the MOF could be manufactured at a much higher yield (in comparison to using a molar ratio of 1:1 of potassium citrate and metal salt) by reacting potassium citrate and a metal salt component at a molar ratio of 1:1.5, without using any organic solvent, at a temperature no greater than, and typically below, about 100° C., and at ambient pressure.

It was further discovered that the MOF could be manufactured from a mixed citric acid salt, e.g., a citrate containing potassium and another metal (such as, M1 or M2), where the ratio between atomic potassium and citrate is no less than 1:1. In more detail, the MOF could be formed by reacting the mixed citric acid salt (K_{1.5}Zn_{0.5}Cit, in an illustrative example) with a metal salt component, e.g., a single metal salt or a mixture of metal salts, in a solvent consisting of water, typically deionized (DI) water. The metal (e.g., M1 or M2) in the single metal salt or one of the metals (M1 or M2) in the mixture of metal (M1+M2) salts can be the same as or different from the metal used in the citrate component containing a citrate of M1 or M2 and potassium. The process could be conducted without using any organic solvent, at a temperature no greater than and typically below about 100° C., and at ambient pressure. Reaction times ranged from 2 hours (h) to 48 h, e.g., from 4 h to 24 h.

In many cases, the overall ratio between citrate and metal was 1:1. Surprisingly and unexpectedly, it was also discovered that the MOF could be manufactured from a mixed metal salt of citric acid, a citrate of part potassium and part another metal (e.g., M1 or M2), essentially as described above, at almost quantitative yield when the overall reactant ratio between citrate and metal salt was 1:1.5.

It was further discovered that the metal salt component and/or the potassium citrate could be formed in situ, also in the absence of an organic solvent. Conditions for the in situ formation of the metal salt component and/or the in situ formation of potassium citrate involve ambient pressure and temperatures that are not greater than 100° C., e.g., within a range of from about 25 to about 95° C.

In more detail, potassium citrate can be formed in situ from precursors that include citric acid. The water/citric acid ratio can be below 10 L/kg (10 liters of water to 1 kg of citric acid), as low as 4 L/kg, for example. In specific examples, citric acid in water, (typically 100% DI water) is reacted with a basic potassium component, such as potassium carbonate, potassium bicarbonate and/or potassium hydroxide.

It is also possible to form the M1 and/or the M2 salt(s) in situ, using, for example, the reaction of a metal carbonate, a metal oxide or a metal hydroxide with an acid, e.g., acetic acid, hydrochloric acid, sulfuric acid, nitric acid, to name a few.

In one embodiment, the invention features a method for preparing a MOF of formula K₂(M1ₓM2₁₋ₓ)₃(Cit)₂, where Cit is fully dehydrogenated citrate anion and M1 and M2 are independently selected metal cations. In one embodiment, M1 and M2 are independently selected cations of Zn, Co, Cu, Mg, Ni, Ca, Mn, Cr, Zr, or Fe. x can be from 0 to 1. In one example, x=0.5. The method includes reacting 1 molar equivalent of citric acid with a metal carbonate (e.g., in an amount of i molar equivalent) and with a basic potassium compound (e.g., in an amount of j molar equivalent), followed by reacting the resulting intermediate with a metal salt component (e.g., in an amount of k molar equivalent). In illustrative examples, x is from 0 and 1.0; i is from 0 to 1; j is from 3 to 1; and k is between 1 and 1.5.

In another embodiment, the invention features a method for preparing a MOF of the formula K₂(M1ₓM2₁₋ₓ)₃(Cit)₂, where Cit is fully dehydrogenated citrate anion, M1 and M2 are independently selected metal cations of, for example, Zn, Co, Cu, Mg, Ni, Ca, Mn, Cr, Zr, or Fe, and x can be from 0 to 1. The method includes reacting potassium citrate (such as, for instance, 1 molar equivalent of potassium citrate) with a metal salt component (such as 1 to 1.5 molar equivalent of a metal salt component), where the metal salt component can be a mixture of a M1 salt and a M2 salt. The reaction is conducted in a solvent consisting of water (e.g., DI water), at a temperature no greater than 100° C. and at the atmospheric pressure of a given location, to produce a solid MOF, e.g., in the form of crystals.

In a further embodiment, the invention features a method for preparing a MOF of formula K₂(M1ₓM2₁₋ₓ)₃(Cit)₂ where Cit is fully dehydrogenated citrate anion, M1 and M2 are independently selected metal cations of Zn, Co, Cu, Mg, Ni, Ca, Mn, Cr, Zr, or Fe, for example, and x can be from 0 to 1. The method comprises reacting citric acid with a metal (M1 or M2) carbonate component (which can be a metal carbonate, a metal oxide and/or a metal hydroxide) and a basic potassium component (such as potassium hydroxide, potassium carbonate, potassium bicarbonate) to form a mixed citrate salt of part potassium and part other metal (e.g., M1 or M2). This resulting intermediate is reacted with a metal salt component, where the metal salt component can be a single metal salt or a mixture of M1 and M2 salts. At least one metal used in the metal salt component can be the same as the non-potassium metal in the mixed metal citrate component. The method is conducted in a solvent consisting of water (e.g., DI water) at a temperature no greater than 100° C. and at ambient pressure. The resulting MOF product is typically a solid in the form of crystals.

One illustrative example employs: 1 molar equivalent of citric acid, a non-potassium metal carbonate component (metal carbonate, metal oxide and/or metal hydroxide) in an amount of 0 to 1.0 molar equivalent and/or a basic potassium compound in an amount of 1.5 to 0.5 molar equivalent. If carbonate species are employed, the total molar equivalent of the non-potassium metal carbonate and potassium carbonate can be 1.5. Another illustrative example employs 1 molar equivalent of citric acid and 1.5 molar equivalent of potassium carbonate.

In many implementations, water (e.g., DI water) is the sole solvent employed in the entire method. It is also possible to conduct at least some of the method steps in an aqueous solvent in which water represents more than 50% based on the total weight of the solvent component.

Typically, the MOF product described herein is a solid precipitate, often in the form of crystals. Further processing, conducted after the MOF product has been formed, can involve separating the precipitate from other reaction ingredients, washing, drying and so forth. Other post synthesis operations can involve identification of the product using techniques such as: its CO₂ adsorption capacity utilizing TGA methods, for example: testing other properties; incorporating the material in devices designed for an end use, and so forth.

In some embodiments, the MOF described herein is used in adsorption applications. Examples include the separation of an acid gas (e.g., CO₂) from a gas mixture such as a flue gas stream or atmospheric air, CO₂ capture and/or CO₂ storage, to name a few.

Accordingly, in yet another of its aspects, the invention features a process for removing an acid gas from a fluid stream containing the acid gas. The process includes contacting the fluid stream with a citrate MOF, whereby at least a portion of the acid gas is adsorbed by the MOF to produce a purified fluid stream. The MOF can be prepared by techniques described herein and has a formula K₂(M1ₓM2₁₋ₓ)₃(Cit)₂, where Cit is fully dehydrogenated citrate anion, M1 and M2 are independently selected metal cations of, for instance, Zn, Co, Cu, Mg, Ni, Ca, Mn, Cr, Zr, or Fe; x can be from 0 to 1.

In further embodiments, the MOF product is used to store the carbon dioxide separated from the gas containing it.

The synthetic procedures for the preparation of UTSA-16 and related MOFs described herein represent significant improvements over existing approaches. Advantages associated with the present invention cannot be overemphasized. For example, conducting the synthesis in water, without organic solvents, reduces costs and eliminates potential VOC emissions. Methods described herein do not require high pressures, high temperatures or microwave reactors, offering increased space-time yield (defined herein as product yield per unit volume of a reactor and per unit time, kg m⁻³ h⁻¹.). Being able to use a molar ratio of 1:1.5 potassium citrate to metal salt offers a higher yield for the MOF production.

Based on convenience, costs, and/or other factors, the K₂(M1ₓM2₁₋ₓ)₃(Cit)₂ MOF can be prepared using various starting materials, offering great flexibility. Being able to synthesize the MOF at ambient temperature and pressure conditions, or even at temperatures below the boiling point of water simplifies the process and/or equipment involved, controlling capital investment, energy requirements and so forth.

Producing some ingredients in situ can reduce overall costs. Also, some of the embodiments described herein reduce the amount of basic potassium compound employed thus reducing the generation of (wasted) potassium salt and increasing the product purity.

The method can be scaled up for pilot studies or for fully industrial applications, using commercially available vessels, reactors, equipment such as, for instance, a conventional jacketed glass reaction vessel.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

FIG. 1 illustrates a general procedure for the synthesis of citric acid based MOFs;

FIG. 2 illustrates examples of synthetic schemes for the synthesis of UTSA-16(Zn);

FIG. 3 is a TGA graph showing the activation of MOF K₂Zn₃(Cit)₂ as prepared in Example 1 at 110 degrees centigrade (° C.) under nitrogen, and the adsorption of CO₂ at 30° C. This MOF exhibited a CO₂ adsorption capacity of 16.3% by weight at 30° C. under atmospheric pressure;

FIG. 4 is a Fourier-transform infrared (FTIR) spectrum of the MOF K₂Zn₃(Cit)₂ as prepared in Example 1;

FIG. 5 is a FTIR spectrum of the bimetallic MOF K₂(Co_{0.5}Zn_{0.5})₃(Cit)₂ as prepared in Example 8;

FIG. 6 is a FTIR spectrum of the MOF K₂Zn₃(Cit)₂ as prepared in Example 9;

FIG. 7 is a powder X-ray diffraction (PXRD) spectrum of the MOF K₂Zn₃(Cit)₂ as prepared in Example 1;

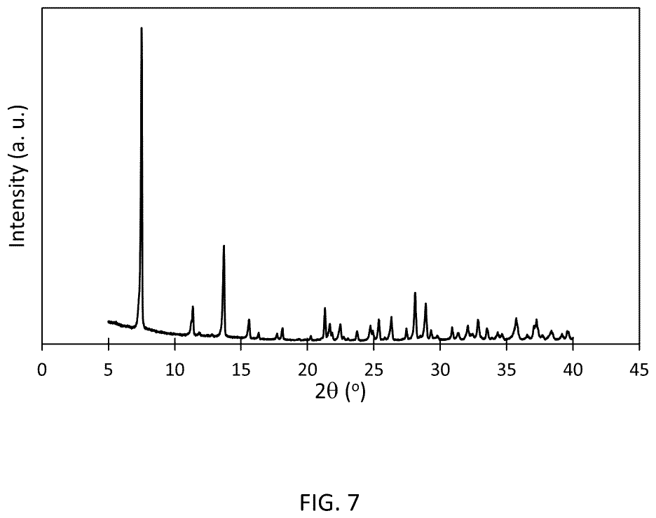

FIG. 8. is a PXRD spectrum of the bimetallic MOF K₂(Co_{0.5}Zn_{0.5})₃(Cit)₂ as prepared in Example 8;

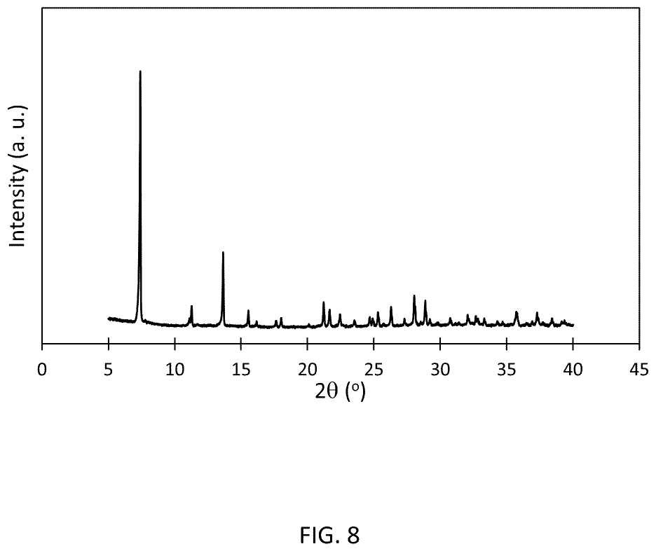

FIG. 9 is a PXRD spectrum of the MOF K₂Zn₃(Cit)₂ as prepared in Example 9, along with a calculated PXRD spectrum of the MOF K₂Zn₃(Cit)₂ and the PXRD spectrum of the MOF K₂Zn₃(Cit)₂ synthesized by the microwave method;

FIG. 10 shows the CO₂, N₂ adsorption isotherms for the MOF K₂Zn₃(Cit)₂ as prepared in Example 9.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments described herein relate to an MOF of the general formula of K₂(M1ₓM2₁₋ₓ)₃(Cit)₂, where Cit is a fully dehydrogenated citrate anion; M1 and M2 are independently selected metal cations of, for example, Zn, Co, Cu, Mg, Ni, Ca, Mn, Cr, Zr, or Fe; and x can be within a range of from 1 to 0. In many embodiments, the MOF has the UTSA-16 structure, a feature believed to contribute to a high acid gas capture capacity.

In light of exiting preparative techniques, it was found, surprisingly and unexpectedly, that the MOF can be manufactured in an aqueous solvent at temperatures that are less than or equal to, and typically below, the boiling point of the solvent, and at ambient pressures.

In most cases, the solvent employed consists of water. For instance, the method described herein can be conducted in a solvent that is 100% water, with no organic solvent being present. For many implementations, the water employed is DI water. (In contrast to DI water, regular, e.g., tap water, may contain metal ions; possibly, the presence of such ions may negatively impact the purity of the product.)

It is also possible to employ a solvent that is an aqueous solution containing an alcohol, for instance. In many cases, the solution will contain more than 50% weight (wt) % water. In many implementations, the organic component present in the aqueous solution is relatively small, for example less than 30, less than 20, less than 10 or less than 5 wt %.

The methods described herein can be conducted at a temperature no greater than and often below 100° C., such as, for example, at a temperature between about 15° C. and about 100° C., e.g., between 25° C. and 95° C. In specific embodiment, the temperature employed is within a range of from about 15° C. to: 25, 35, 45, 55, 65, 75, 85, 95, 100° C.; or from 25° C. to: 35, 45, 55, 65, 75, 85, 95, 100° C.; or from 35° C. to: 45, 55, 65, 75, 85, 95, 100° C.; or from 45° C. to: 55, 65, 75, 85, 95, 100° C.; or from 65° C. to: 75, 85, 95, 100° C.; or from 75° C. to: 85, 95, 100° C.; or from 85° C. to 95, 100° C.; or from 95 to 100° C.

Typically, the pressure employed is the ambient pressure, i.e., the atmospheric pressure of a given location.

In specific embodiments, a MOF of formula K₂(M1ₓM2₁₋ₓ)₃(Cit)₂, where Cit is fully dehydrogenated citrate anion, and M1 and M2 are independently selected metal cations of e.g., Zn, Co, Cu, Mg, Ni, Ca, Mn, Cr, Zr, or Fe, can be formed utilizing potassium citrate as the starting material. The potassium citrate starting material is combined with a metal salt or a mixture of metal salts in water, typically in pure DI water, without any organic solvent, at temperature and/or pressure conditions such as described above.

The counter anion forming the salt(s) can be independently selected from: acetate (Ac⁻); chloride (Cl⁻); nitrate (NO₃⁻); sulfate (SO₄²⁻); or another suitable anion. With salt mixtures, the anion for the M1 salt can be the same or different from the anion in the M2 salt. Even cases in which M1 is the same as M2 can employ a mixture of salts of the same metal.

To illustrate, a bimetallic (e.g., Zn and Co) MOF can be prepared using two different metal salts (e.g., a mixture of two different metal salts, in this case a salt of Zn and a salt of Co). A mixture of salts of either or both Zn and Co also can be employed. A single metal MOF, a Co MOF, for instance, can be prepared by using a single metal salt, in this case a cobalt salt. It is also possible to prepare a single metal MOF using different salts of the same metal, M1 being the same as M2 and the salts differing with respect to the anion present.

The molar ratio between the metal salt component (a single salt or a mixture of salts, as described above) and potassium citrate is at least 1, e.g., within a range of from about 1.5 to 1. A molar ratio of 1.5 is preferred, as it offers high yield for the MOF production.

The reaction of potassium citrate with the metal salt component is carried out at temperature and pressure conditions such as described above. The typical reaction time can be within a range of from about 2 hours (h) to about 48 h, often from about 4 h to about 24 h.

Some of the ingredients employed in the method described herein can be formed in situ, from suitable precursors.

A metal salt, for instance, can be formed in situ through the reaction of a metal carbonate, a metal oxide, or a metal hydroxide with an acid, e.g., acetic acid, hydrochloric acid, sulfuric acid, or nitric acid. For convenience, as used herein, the term “metal carbonate component” includes one or more of a metal carbonate, a metal oxide or a metal hydroxide. To illustrate, zinc acetate can be formed in situ by reacting zinc oxide (or zinc carbonate or zinc hydroxide) with acetic acid. The formation of zinc acetate in situ can reduce the overall cost for preparing the zinc MOF.

Potassium citrate can be formed in situ by reacting citric acid with a basic (as opposed to acidic) potassium compound, such as potassium carbonate, potassium bicarbonate or potassium hydroxide. This step can be conducted in an aqueous solution, e.g., in pure (100%) DI water. An ideal molar ratio for potassium carbonate to citric acid is about 1.5; an ideal molar ratio for potassium bicarbonate to citric acid is about 3.0; and an ideal molar ratio for potassium hydroxide to citric acid is about 3.0. Variations of these ratios can be utilized. In some cases, however, using ratios other than the ideal ones may result in lower yields and/or lower product purity. Temperature and pressure conditions employed in the in situ formation of potassium citrate can be the same as those described above. Reaction times to form the potassium citrate using a basic potassium compound can be within a range of from about 10 minutes to about 2 hours. Longer reaction time can be utilized, but at a lower space-time yield.

In some cases, the basic potassium compound (e.g., potassium carbonate, potassium oxide and/or potassium hydroxide) is supplements with a metal carbonate to form a mixed citrate salt intermediate. In turn, the metal carbonate can be replaced or supplemented by a metal oxide and/or a metal hydroxide. (As already noted, compounds such as a metal carbonate, a metal oxide, a metal hydroxide, or any combination thereof are referred to herein as a “metal carbonate component”.) The metal carbonate component can include metals M1 and M2, where M1 and M2 are the same or different and are independently selected from a group such as the group consisting of Zn, Co, Cu, Mg, Ni, Ca, Mn, Cr, Zr, and Fe.

The completion of the reaction between citric acid and the metal carbonate component is followed by adding the basic potassium compound (solid potassium carbonate or potassium bicarbonate or potassium hydroxide). If potassium carbonate is used, the molar equivalent of potassium carbonate is, in one implementation, 1.5 minus the molar equivalent of the metal carbonate(s) utilized in the preceding step; for potassium bicarbonate, the molar equivalent of potassium bicarbonate can be two times 1.5, minus the molar equivalent of the metal carbonate(s); and, for potassium hydroxide, the molar equivalent can be two times 1.5, minus the molar equivalent of the metal carbonate(s). In many examples, the atomic ratio between potassium and citrate is at least 1. The metal or metals in the metal carbonate component can be the same as the metal or metals the salt component. As further described below, different metals can be used to prepare bimetallic MOFs. In a simple illustrative example, the citrate component will contain M1, while the salt component will contain M2.

Various synthetic approaches can be employed, all being conducted in the absence of an organic solvent, at temperatures no greater than 100° C. and atmospheric pressure.

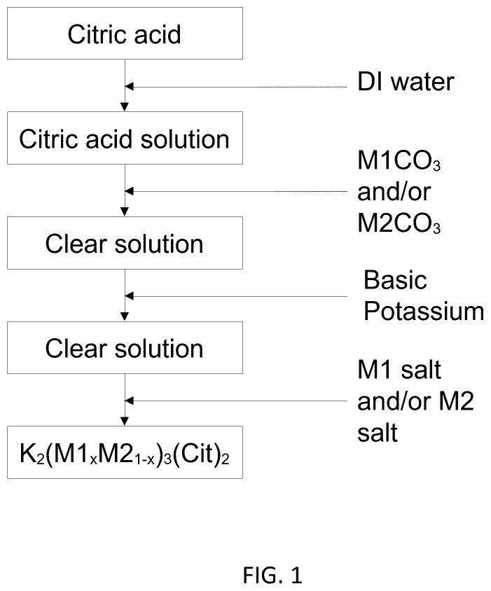

In one implementation (see, e.g., FIG. 1), citric acid is first reacted with a metal carbonate component, e.g., M1CO₃ and/or M2CO₃. The reaction is conducted in an aqueous solvent, typically in pure (100%) DI water. This reaction (with the metal carbonate compound) is conducted at a temperature between 15 and 90° C., at atmospheric pressure, over a time interval such as 10 minutes to 2 hours. The reaction is then followed by reacting with a basic potassium compound, e. g. potassium hydroxide, or potassium carbonate, or potassium bicarbonate.

Different mixing sequences can be employed. In one example, the basic potassium compound is combined with citric acid first, followed by the combination with the metal carbonate component.

Partially reacting citric acid with the metal carbonate component decreases the requirement for basic potassium compound, resulting in higher product purity and less potassium salt formation, typically a waste byproduct.

The preliminary step of forming in situ potassium citrate, can be followed by adding the metal salt component (as described above). The metal salt component can be provided in an aqueous solution such as pure (100%) DI water. The reaction is carried out at a temperature such as described above, e.g., between 15° C. and 100° C., preferably between 25° C. and 95° C., and at ambient pressure. The reaction time is between 2 h to 48 h, often between 4 h and 24 h. The molar ratio between the metal salt and the citric acid used as a precursor to form in situ potassium citrate or mixed citrate salt can be at least about 1, and preferably higher. In specific examples the ratio between the metal salt and the citric acid used as a precursor to form in situ potassium citrate or mixed citrate salt is within a range of from about 1 to about 1.5.

At least one of the metal salts employed can be formed in situ, by reacting a metal carbonate, metal hydroxide and/or a metal oxide (i.e., a metal carbonate component) with an acid. For instance, zinc acetate can be formed by reacting acetic acid with zinc oxide, or by reacting acetic acid with (basic) zinc carbonate.

In one example, citric acid is first partially reacted with a metal oxide, ZnO, for example, then with a basic potassium component, e.g., KOH, completely, to form a mixed metal (e.g., K, Zn) salt of citric acid. The mixed salt further reacts with a metal salt, e.g., ZnAc₂, to form the crystalline MOF.

In another approach, potassium citrate salt reacts with ZnAc₂ to form the MOF. In a further approach, the MOF is formed by reacting a mixed metal citrate salt (a citrate of potassium and a citrate of another metal, e.g., Zn) with ZnAc₂. The reactant ratio between the citrate and the metal salt (e.g., ZnAc₂) is within a range of from about 1:1 to about 1:1.5.

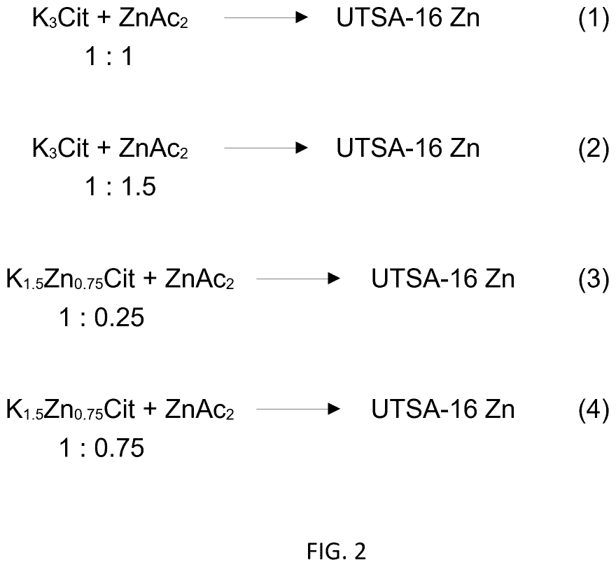

FIG. 2 illustrates examples of synthetic schemes for the synthesis of UTSA-16(Zn) and shows: (1) reaction of potassium citrate with zinc acetate in water with citrate/zinc molar ratio of 1:1; (2) reaction of potassium citrate with zinc acetate in water with citrate/zinc molar ratio of 1:1.5; (3) reaction of K_{1.5}Zn_{0.75}Cit mixed salt with zinc acetate in water with citrate/zinc molar ratio of 1:1; and (4) reaction of K_{1.5}Zn_{0.75}Cit mixed salt with zinc acetate in water with citrate/zinc molar ratio of 1:1.5.

Variations in the approach described above can offer additional options. In one example, the procedure is adapted to the preparation of bimetallic MOF based on the in situ formation of citrate by using different metals in the metal carbonate component and the metal salt component. To illustrate, a Co/Zn bimetallic citrate MOF can be prepared by selecting CoCO₃ (for the metal carbonate component) and zinc acetate (for the metal salt component). Another example employs a mixture of metal salts. For instance, one could select zinc carbonate and a mixture of cobalt acetate/zinc acetate to prepare a Co/Zn bimetallic citrate MOF. As previously discussed, the metal carbonate can be replaced or supplemented with metal oxide, or metal hydroxide, and/or mixture thereof.

Generally, ingredients can be combined in any manner suitable to prepare the MOF. Accordingly, ingredients can be combined all at once (simultaneously), sequentially, incrementally, and so forth. In one illustration, the addition of a solution or of a solid compound to another solution can be carried stepwise, over a period of time (e.g., several minutes to several hours).

Mixing operations can be conducted by stirring, shaking, ball milling, etc., using equipment known in the art. Heating can be provided by hot plates, heating tape, heating jackets, heat exchangers, ovens, to name a few. Drying can be air drying, in the ambient environment, in ovens, microwave ovens, vacuums, and so forth. Product separation can rely on techniques such as decanting, filtration, centrifuging, and/or others.

As already noted, the MOF product obtained by approaches such as described above is a solid material, typically in the form of crystals. Identification and/or characterization of the MOF can be performed using techniques such as powder x-ray diffraction (PXRD), and CO₂ adsorption. Adsorption properties, e.g., with respect to CO₂ adsorption, can be measured by thermogravimetric analysis (TGA). In one example, a situation in which a product does not have any CO₂ adsorption capacity (by TGA) indicates that the MOF was not formed.

The MOF product can have an adsorption capacity for pure CO₂ at 30° C., atmospheric pressure, within a range from about 13 wt % to about 17 wt %. In one example, the MOF has a calculated Ideal Adsorbed Solution Theory (IAST) CO₂/N₂ selectivity above 200. The heat of adsorption of the MOF can be between about 20 kJ/mol and about 40 kJ/mol.

The MOF manufactured according to embodiments described herein can be used to adsorb an acid gas (CO₂, for example). In one embodiment, the acid gas is removed from a fluid stream, e.g., a flue gas stream by bringing the fluid stream containing the acid gas into contact with the MOF adsorbent. As at least a portion of the acid gas (e.g., CO₂) becomes adsorbed by the MOF, the fluid stream is depleted in the acid gas (e.g., CO₂), generating a stream that is purified with respect to the acid gas. Acid gases other than CO₂ that can be adsorbed include SO₂, H₂S, and/or others, as known in the art.

For adsorption-based applications, the MOF can be provided without further processing, as solid crystals, for example. In a different approach, the solid MOF product prepared as described above can be subjected to additional operations to form beads, pellets, fibers, etc., by techniques known in the art or developed in the future.

For many applications, the MOF adsorbent is packaged into a structured cartridge, a bed or another article.

Columns or beds (e.g., fixed, or moving beds) that are packed with the MOF adsorbents described herein can be constructed and/or operated as known in the art.

Adsorbents containing a contaminant such as an acid gas (e.g., CO₂), for instance, can be regenerated for reuse or for environmentally safe disposal. Various methods can be employed, using heat, vacuum, lower pressure, or any combination thereof. If the regeneration technique relies on heat, the desorption process can be a temperature swing adsorption (TSA) method, while many processes based on lowered pressures are known as pressure swing adsorptions (PSA). Another useful technique that can be employed to release adsorbed species from the MOF adsorbents described herein involves both heating and vacuum, the process being known as temperature-vacuum swing adsorption or TVSA.

These techniques are well known in the art (see, e.g., U.S. Pat. Nos. 9,457,340, and 8,974,577, the entire contents of both being incorporated herein by this reference) and can be used in conjunction with beads, fibers, sheets, bulk adsorbing materials or articles, etc.

In some embodiments, steam can be directed to the MOF adsorbent directly to regenerate the adsorbent.

Temperatures, pressures and/or other parameters relevant to the adsorption or desorption stage can be monitored or controlled using techniques and devices known in the art. Adjustments can be made by an operator, for example. In automated processes, conditions and parameters can be computer controlled.

The citrate MOF prepared as described herein also can find applications in the direct removal of an acid gas from an ambient atmosphere. Some approaches that can be employed to capture carbon dioxide from the atmosphere typically rely on a blower to circulate the air through the adsorbents. As carbon dioxide is adsorbed, clean air is released. Once the adsorbents are saturated with carbon dioxide, the air circulation is directed to another adsorbent device, while the saturated adsorbent is regenerated by heat, or vacuum, or a combination of both. The heat source can be from renewable energy sources, such as solar or wind energy.

The carbon dioxide released from the MOF adsorbents described herein can be utilized for enhanced oil recovery, to prepare synthetic fuels, such as methanol, methane, jet fuels, etc. In some embodiments, the carbon dioxide is injected for storage.

The invention is further illustrated in the following non-limiting exemplification section.

### EXAMPLES

### Example 1. Synthesis of K₂Zn₃(Cit)₂ from Potassium Citrate at 90° C.

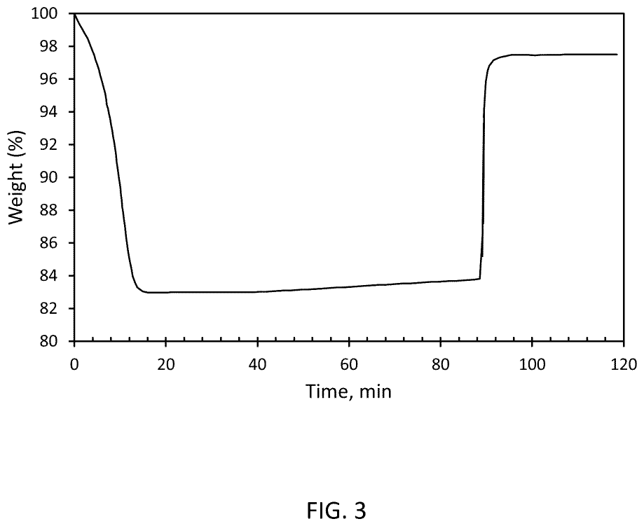

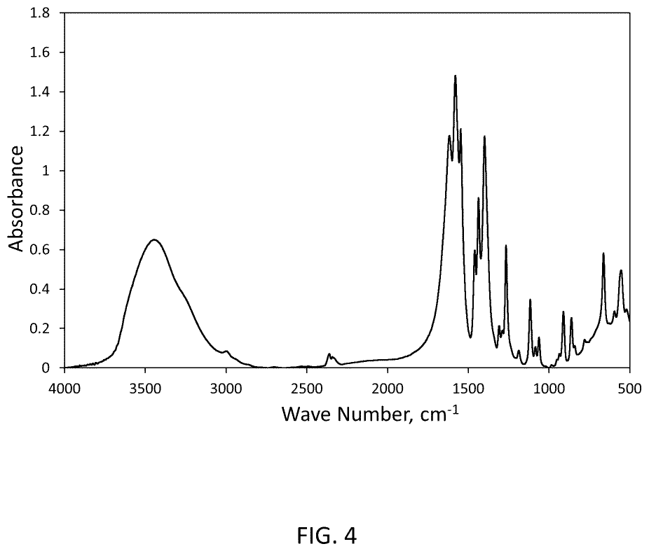

Potassium citrate monohydrate (32.44 g, 0.1 mol) was dissolved in DI water (40 mL); zinc acetate dihydrate (21.95 g, 0.1 mol) was dissolved in DI water (60 mL). The two solutions were combined and formed a clear solution. The combined solution was stirred at room temperature for 1 hour (h), after which it was placed in an oven set at 90° C. for 20 h. The solution was then cooled down to room temperature and filtered. The solid retained in the filter was washed with water and ethanol. An amount of 16.76 g of MOF K₂Zn₃(Cit)₂ was obtained after air drying and drying at 50° C. overnight. The MOF exhibited a CO₂ adsorption capacity of 16.3% by weight at 30° C. under a pure CO₂ atmosphere as measured by TGA after activation at 110° C. for 30 minutes (as shown in FIG. 3). The FTIR spectrum of the MOF K₂Zn₃(Cit)₂ prepared in this example is presented in FIG. 4.

### Example 2. Synthesis of K₂Zn₃(Cit)₂ from Potassium Citrate at Room Temperature

Potassium citrate monohydrate (32.44 g, 0.1 mol) was dissolved in DI water (40 mL); zinc acetate dihydrate (21.95 g, 0.1 mol) was dissolved in DI water (60 mL). The two solutions were combined to form a clear solution, which was stirred at room temperature for 20 h. The solution was then filtered and the product was washed with water and ethanol. Air drying was followed by drying at 50° C. overnight. An amount of 15.32 g of MOF K₂Zn₃(Cit)₂ was obtained. The MOF exhibited a CO₂ adsorption capacity of 15.8% by weight at 30° C. under pure CO₂ atmosphere as measured by TGA after activation at 110° C. for 30 minutes.

### Example 3. Synthesis of K₂Zn₃(Cit)₂ from Citric Acid and Potassium Carbonate

Anhydrous citric acid (19.21 g, 0.1 mol) was first dissolved in DI water (20 mL). Potassium carbonate (20.73 g, 0.15 mol) in powder form was added to the citric acid solution slowly with effervescence to form a clear potassium citrate solution. Zinc acetate dihydrate (21.95 g, 0.1 mol) was dissolved in DI water (60 mL) and the resulting solution was added to the potassium citrate solution, forming a clear solution, which was further stirred at room temperature for 1 h and then placed in an oven set at 90° C. for 20 h. The solution was then cooled to room temperature and filtered. Solids were washed with water and ethanol. of MOF K₂Zn₃(Cit)₂, in an amount of 16.52 g, was obtained after air drying, followed by drying at 50° C. overnight. The MOF exhibited a CO₂ adsorption capacity of 16.5% by weight at 30° C. under pure CO₂ atmosphere as measured by TGA after activation at 110° C. for 30 minutes.

### Example 4. Synthesis of K₂Zn₃(Cit)₂ from Potassium Citrate with Zinc/Citrate at a Ratio of 1.5

Two solutions were prepared as follows. Potassium citrate monohydrate (21.64 g, 0.067 mol) was dissolved in DI water (20 mL); zinc acetate dihydrate (21.96 g, 0.10 mol) was dissolved in DI water (60 mL). The two solutions were combined to form a clear solution. The resulting clear solution was further stirred at room temperature for 1.5 h, and then placed in an oven set at 90° C. for 20 h. Afterwards, the solution was cooled to room temperature and filtered. Solids were washed with water and ethanol, air dried, then dried at 50° C. overnight. An amount of 20.67 g of MOF K₂Zn₃(Cit)₂ was obtained. The product MOF exhibited a CO₂ adsorption capacity of 13.9% by weight at 30° C. under pure CO₂ atmosphere as measured by TGA after activation at 110° C. for 30 minutes.

### Example 5. Synthesis of K₂Zn₃(Cit)₂ from Citric Acid and Zinc Carbonate at 90° C.

Anhydrous citric acid (19.21 g, 0.1 mol) was first dissolved in DI water (40 mL). Solid basic zinc carbonate (8.45 g, 0.075 mol) was added to the citric acid solution slowly, with effervescence, to form a clear solution. Anhydrous potassium carbonate (10.37 g, 0.075 mol) was then added to this clear solution slowly, with effervescence. Zinc acetate dihydrate (5.49 g, 0.025 mol) was dissolved in DI water (15 mL) and added into the above solution. The resulting solution was stirred at room temperature for 1 h and then placed in an oven set at 90° C. for 4 h. Afterwards, the solution was cooled to room temperature, filtered and washed with water and ethanol. An amount of 18.52 g of MOF K₂Zn₃(Cit)₂ product was obtained after air drying and drying at 50° C. overnight. The MOF exhibited a CO₂ adsorption capacity of 15.4% by weight at 30° C. under pure CO₂ atmosphere as measured by TGA.

### Example 6. Synthesis of K₂Zn₃(Cit)₂ from Citric Acid and Zinc Carbonate at Room Temperature

Anhydrous citric acid (19.21 g, 0.1 mol) was first dissolved in DI water (40 mL). Solid basic zinc carbonate (8.45 g, 0.075 mol) was added to the citric acid solution slowly with effervescence to form a clear solution. Then, anhydrous potassium carbonate (10.37 g, 0.075 mol) was added to the above solution slowly with effervescence. Zinc Acetate dihydrate (5.49 g, 0.025 mol) was dissolved in DI water (15 mL) and added into the above solution. The combined solution was further stirred at room temperature for 20 h. The solution was then filtered and washed with water and ethanol. After air drying and drying at 50° C. overnight, a MOF K₂Zn₃(Cit)₂ product was obtained in an amount of 15.70 g. The MOF exhibited a CO₂ adsorption capacity of 13.4% by weight at 30° C. under pure CO₂ atmosphere as measured by TGA technique after activation at 110° C. for 30 minutes.

### Example 7. Synthesis of K₂Zn₃(Cit)₂ from Citric Acid and Zinc Carbonate with Zinc/Citrate Ratio of 1.5

Anhydrous citric acid (19.21 g, 0.1 mol) was first dissolved in DI water (40 mL). Solid basic zinc carbonate (8.45 g, 0.075 mol) was added to the citric acid solution slowly with effervescence to form a clear solution. This was followed by adding anhydrous potassium carbonate (10.37 g, 0.075 mol) to the above solution slowly with effervescence. Zinc acetate dihydrate (16.47 g, 0.075 mol) was dissolved in DI water (45 mL) and added into the solution that was formed with the addition of the anhydrous potassium carbonate. The resulting solution was stirred at room temperature for 1.5 h and then placed in an oven set at 90° C. for 6 h. The solution was then cooled down to room temperature, filtered and washed with water and ethanol. An amount of 33.35 g of MOF K₂Zn₃(Cit)₂ was obtained after air drying and drying overnight at 50° C. The MOF exhibited a CO₂ adsorption capacity of 15.3% by weight at 30° C. under pure CO₂ atmosphere as measured by TGA technique after activation at 110° C. for 30 minutes.

### Example 8. Synthesis of K₂(Co_{0.5}Zn_{0.5})₃(Cit)₂ from Citric Acid and Cobalt Carbonate

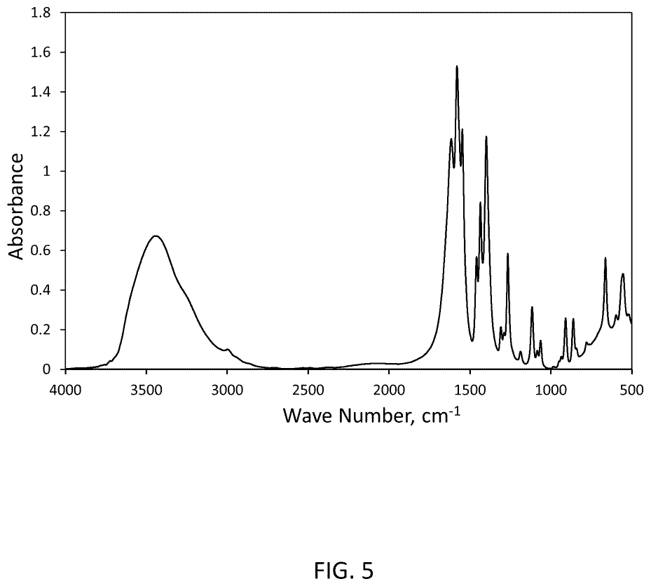

Anhydrous citric acid (19.21 g, 0.1 mol) was first dissolved in DI water (40 mL). Solid basic zinc carbonate (8.45 g, 0.075 mol) was added to the citric acid solution slowly with effervescence to form a clear solution. Solid CoCO₃ xH₂O (5.95 g, 0.05 mol) was then added to this clear solution slowly with effervescence, followed by the addition of solid basic zinc carbonate (2.82 g, 0.025 mol). Solid anhydrous potassium carbonate (10.37 g, 0.075 mol) was added to the above solution, forming a dark red solution. Zinc acetate dihydrate (5.49 g, 0.025 mol) was dissolved in DI water (15 mL) and added into the dark red solution. The resulting solution was stirred at room temperature for 1 h and then placed in an oven set at 90° C. for 20 h. The solution was then cooled to room temperature, filtered and washed with water and ethanol. An amount of 16.00 g of MOF K₂(Zn_{0.5}Co_{0.5})₃(Cit)₂ was obtained after air drying and drying at 50° C. overnight. The bimetallic MOF exhibited a CO₂ adsorption capacity of 16.4% by weight at 30° C. under pure CO₂ atmosphere as measured by TGA after activation at 110° C. for 30 min. A FTIR spectrum of the bimetallic MOF obtained is shown in FIG. 5.

### Example 9. Synthesis of K₂Zn₃(Cit)₂ from Citric Acid and Zinc Oxide with Zinc/Citrate Ratio of 1.5

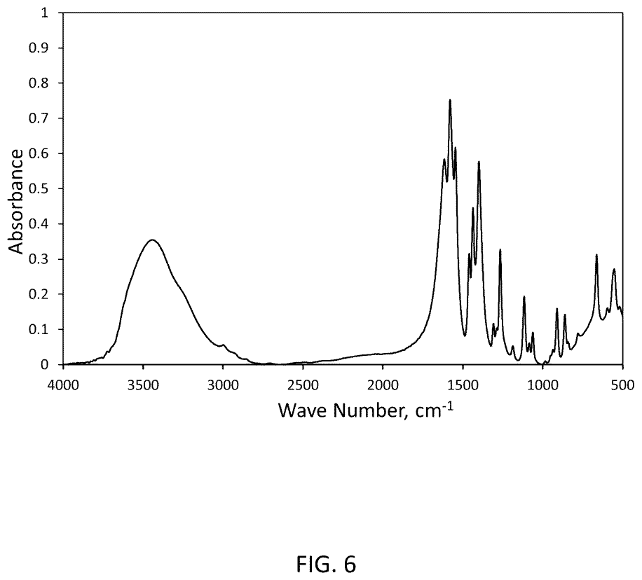

Anhydrous citric acid (19.21 g, 0.1 mol) was first dissolved in DI water (40 mL). Solid zinc oxide powder (6.11 g, 0.075 mol) was added to the citric acid solution slowly, with stirring. This was followed by adding anhydrous potassium carbonate (10.37 g, 0.075 mol), slowly with effervescence. Zinc acetate dihydrate (16.47 g, 0.075 mol) was dissolved in DI water (45 mL) and added into the above solution. The resulting solution was stirred at room temperature for 1.5 h, then placed in an oven set at 60° C. for 24 h. This was followed by cooling the resulting solution to room temperature, filtration and washing with water and ethanol. An amount of 33.81 g of MOF K₂Zn₃(Cit)₂ was obtained after air drying and drying at 50° C. overnight. The MOF exhibited a CO2 adsorption capacity of 15.41% by weight at 30° C. under pure CO₂ atmosphere as measured by TGA after activation at 110° C. for 30 minutes. FIG. 6 is a FTIR spectrum of the MOF obtained in this example.

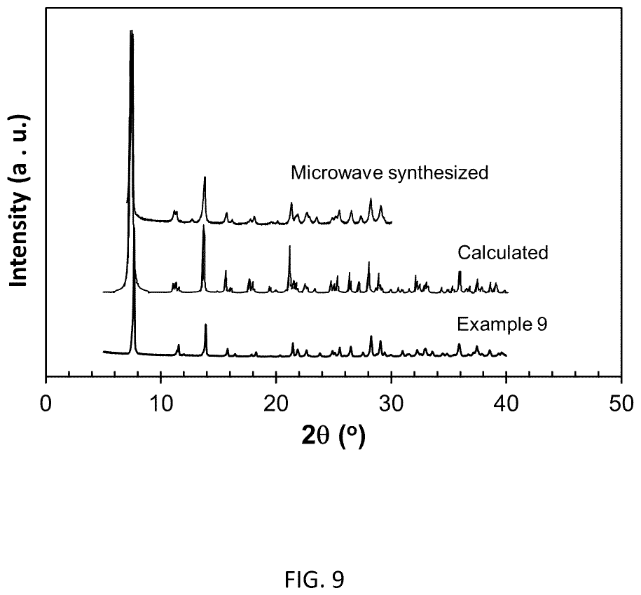

Shown in FIG. 9 is a comparison of the PXRD spectrum of the MOF prepared according to this example; a calculated spectrum of this MOF, based on the reported crystallographic structure from the Cambridge Structural Database (CSD) for Metal-Organic Frameworks (MOFs); and a PXRD of the corresponding MOF prepared by the microwave method as reported by Sanjit Gaikwad et al. in the paper titled Novel metal-organic framework of UTSA-16 (Zn) synthesized by a microwave method: Outstanding performance for CO₂ capture with improved stability to acid gases, J. Ind. Eng. Chem., 2020, 87, page 250. As seen in the figure, the three spectra show no difference between the MOF prepared according to embodiments disclosed herein and the MOF prepared by conventional techniques. That the MOF obtained in Example 9 is the same as that obtained by the microwave technique is further supported by the calculated PXRD spectrum.

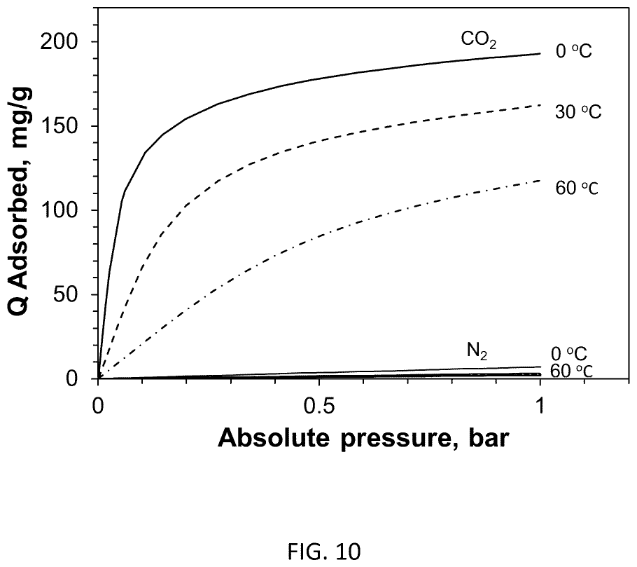

The CO₂ and N₂ adsorption isotherms for the MOF K₂Zn₃(Cit)₂ prepared according to Example 9 are presented in FIG. 10 and indicate that the MOF prepared according to this example displayed excellent CO₂ adsorption capacities at a wide range of CO₂ partial pressures. The calculated Ideal Adsorbed Solution Theory (IAST) CO₂/N₂ selectivity is greater than 320 and the calculated heat of adsorption is 32.7 kJ/mol.

### Example 10. Synthesis of K₂Zn₃(Cit)₂ from Citric Acid, Zinc Oxide and Zinc Acetate Formed in Situ with Zinc/Citrate Ratio of 1.5

Anhydrous citric acid (19.21 g, 0.1 mol) was first dissolved in DI water (40 mL). Solid potassium hydroxide flake (8.42 g, 0.15 mol) was added to the citric acid solution slowly, with stirring. A clear solution was formed and 45% vinegar (21.1 cc, 0.16 mol) was added into this clear solution. Solid zinc oxide powder (12.21 g, 0.15 mol) was then added to the solution slowly, with stirring. The resulting solution was stirred at room temperature for 1.5 h and then placed in an oven set at 60° C. for 24 h. After cooling to room temperature, the solution was filtered and washed with water and ethanol. An amount of 36.29 g of MOF K₂Zn₃(Cit)₂ was obtained after air drying and drying at 50° C. overnight. The MOF exhibited a CO2 adsorption capacity of 12.90% by weight at 30° C. under pure CO₂ atmosphere as measured by TGA after activation at 110° C. for 30 minutes.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for preparing a MOF having a formula of K₂(M1ₓM2₁₋ₓ)₃(Cit)₂, where Cit is fully dehydrogenated citrate anion, M1 and M2 are independently selected metal cations of Zn, Co, Cu, Mg, Ni, Ca, Mn, Cr, Zr, or Fe, and x is from 0 to 1, the method comprising:
(a) reacting 1 molar equivalent of citric acid with i molar equivalent of a metal carbonate component and with j molar equivalent of a basic potassium compound;
(b) reacting the product of (a) with k molar equivalent of a metal salt component, to produce the MOF, wherein the method is conducted in a solvent consisting of water at ambient pressure and at a temperature no greater than 100° C.

2. The method of claim 1, wherein the salt component includes a salt of M1 and/or a salt of M2.

3. The method of claim 2, wherein the counter anions for the M1 and/or M2 salt are independently selected from the group consisting of Ac⁻, Cl⁻, NO₃⁻ and SO₄²⁻.

4. The method of claim 1 wherein i is from 0 to 1.0, j is from 3.0 to 1.0, and k is from 1.0 to 1.5.

5. The method of claim 1, wherein M1 is Zn, and x is 1 and the MOF has a formula of K₂Zn₃(Cit)₂.

6. The method of claim 1, wherein M1 is Co and x is 1 and the MOF has a formula of K₂Co₃(Cit)₂.

7. The method of claim 1, wherein the temperature is between 15° C. and 100° C.

8. The method of claim 1, wherein i is 0.

9. The method of claim 1, wherein the basic potassium compound is potassium carbonate, potassium bicarbonate, and potassium hydroxide.

10. The method of claim 1, wherein the metal salt component is formed in situ by reacting an acid with a metal oxide, metal hydroxide, and/or a metal carbonate.

11. A process for removing an acid gas from a fluid stream containing the acid gas, the process comprising:
contacting the fluid stream with a MOF adsorbent, whereby at least a portion of the acid gas is adsorbed by the MOF adsorbent to produce a purified fluid stream,
wherein,
the MOF has a formula of K₂(M1ₓM2₁₋ₓ)₃(Cit)₂, where Cit is fully dehydrogenated citrate anion,
M1 and M2 are independently selected metal cations of Zn, Co, Cu, Mg, Ni, Ca, Mn, Cr, Zr, or Fe, and x is from 0 to 1, where the MOF is prepared by a method comprising:
(a) reacting 1 molar equivalent of citric acid with i molar equivalent of a metal carbonate component and with j molar equivalent of a basic potassium compound;
(b) reacting the product of (a) with k molar equivalent of a metal salt component, to produce the MOF, wherein the method is conducted in a solvent consisting of water at ambient pressure and at a temperature no greater than 100° C.

12. The process of claim 11, wherein the metal salt component includes a salt of M1 and/or a salt of M2.

13. The process of claim 12, wherein the counter anions for M1 and/or M2 are independently selected from the group consisting of Ac⁻, Cl⁻, NO₃⁻ and SO₄²⁻.

14. The process of claim 11, wherein x is from 0 to 1.0.

15. The process of claim 11, wherein i is from 0 to 1.0, j is from 3.0 to 1.5, and k is from 1.0 to 1.5.

16. The process of claim 11, wherein M1 is Zn, and x is 1 and the MOF has a formula of K₂Zn₃(Cit)₂.

17. The process of claim 11, wherein M1 is Co and x is 1 and the MOF has a formula of K₂Co₃(Cit)₂.

18. The process of claim 11, wherein the temperature is between 15° C. and 95° C.

19. The process of claim 11, wherein i is 0.

20. The process of claim 11, wherein the basic potassium compound includes potassium carbonate, potassium bicarbonate, and/or potassium hydroxide.

21. The process of claim 11, wherein metal salt is formed in situ by reacting an acid with metal oxide, and/or a metal carbonate.

22. The process of claim 11, wherein the acid gas is CO₂, SO₂ or H₂S.

23. The process of claim 11, wherein the fluid stream is a flue gas from a point of source.

24. The process of claim 11, wherein the fluid stream is atmospheric air.

25. A process for removing an acid gas from a fluid stream containing the acid gas, the process comprising:
preparing a MOF having a formula of K₂(M1ₓM2₁₋ₓ)₃(Cit)₂, where Cit is fully dehydrogenated citrate anion, M1 and M2 are independently selected metal cations of Zn, Co, Cu, Mg, Ni, Ca, Mn, Cr, Zr, or Fe, and x is from 0 to 1, by a method comprising:
(i) reacting 1 molar equivalent of citric acid with i molar equivalent of a metal carbonate component and with j molar equivalent of a basic potassium compound;
(ii) reacting the product of (a) with k molar equivalent of a metal salt component, to produce the MOF, wherein steps (i) and (ii) are conducted in a solvent consisting of water at ambient pressure and at a temperature no greater than 100° C.; and
contacting the fluid stream containing the acid gas with the MOF, whereby at least a portion of the acid gas is adsorbed by the MOF, to produce a purified fluid stream.
